(19) United States
(12) Patent Application Publication
(10) Pub. No.: US 2023/0231156 A1
(43) Pub. Date: Jul. 20, 2023

(54) SEALING MEMBER, POWER GENERATING UNIT CELL, AND METHOD OF PRODUCING FUEL CELL

(71) Applicant: TOYOTA JIDOSHA KABUSHIKI KAISHA, Toyota-shi (JP)

(72) Inventors: Nobuaki NONOYAMA, Toyota-shi (JP); Takuya HATTORI, Toyota-shi (JP)

(21) Appl. No.: 18/060,619

(22) Filed: Dec. 1, 2022

(30) Foreign Application Priority Data
Jan. 18, 2022 (JP) 2022-005748

(51) Int. Cl. H01M 8/0271; H01M 8/0286

(52) U.S. Cl. CPC H01M 8/0271; H01M 8/0286

(57) ABSTRACT

Provided is a sealing member that can suppress a deterioration in sealability over time. The sealing member is arranged between a cathode separator and an anode separator, with the sealing member the cathode separator and the anode separator being adhered and a space therebetween being sealed, the cathode separator and the anode separator being provided for a power generating unit cell in a fuel cell, the sealing member including: a base material; and an adhesive layer arranged on at least one face of the base material, wherein the adhesive layer contains many bubbles in an adhered state.

### FIELD

The present disclosure relates to a fuel cell.

### BACKGROUND

Patent Literature 1 discloses: superposing components and thermoplastic resin porous bodies to form a stack, the thermoplastic resin porous bodies include closed cells and expand by heating to be elastic bodies as intervening between each of the components; and performing a heating process after the stack is formed so as to expand to closely adhere the thermoplastic resin porous bodies to each of the components, so that a fluid is sealed in the stack.

Patent Literature 2 discloses that a gasket is stuck on a surface of a separator using an adhesive to form a structure of one body, wherein the gasket consists of a foam rubber layer disposed on the surface of a metal plate.

Patent Literature 3 discloses a structure of a gasket bonded through a closed-cell spongy layer thereof to at least one face of a separator via an adhesive layer.

### CITATION LIST

### Patent Literature

Patent Literature 1: JP S63-211570 A
Patent Literature 2: JP 2000-156234 A
Patent Literature 3: JP H9-97619 A

### SUMMARY

### Technical Problem

The sealing members found in the conventional arts are provided with porous elastic bodies. However, the sealing is performed by contact and pressing in these conventional arts. Such sealing leads to lowered pressure in the bubbles in the porosity as time passes due to gas permeability to decrease the pressing force, which also deteriorates the sealability, which is problematic.

In view of the above problem, an object of the present disclosure is to provide a sealing member that can suppress a deterioration in sealability over time. A power generating unit cell using this sealing member, and a method of producing a fuel cell using this sealing member are also provided.

### Solution to Problem

The present application discloses a sealing member that is arranged between a cathode separator and an anode separator, with the sealing member the cathode separator and the anode separator being adhered and a space therebetween being sealed, the cathode separator and the anode separator being provided for a power generating unit cell in a fuel cell, the sealing member comprising: a base material; and an adhesive layer arranged on at least one face of the base material, wherein the adhesive layer contains many bubbles in an adhered state.

The percentage of the bubbles in the adhesive layer in the adhered state may be 10% to 80%.

The present application discloses a power generating unit cell for a fuel cell, the power generating unit cell being formed by holding a membrane electrode assembly between two separators, wherein the above-described sealing member is arranged outside a circumferential part of the membrane electrode assembly, and the adhesive layer adheres to one of the separators.

The peel strength for adhesion of the adhesive layer to the one of the separators may be more than 0.2 N/mm.

The present application is a method of producing a fuel cell, the method comprising: forming a stack by arranging a membrane electrode assembly between two separators, outside a circumference of the membrane electrode assembly a sealing member including at least one adhesive layer being arranged, and heating the stack formed by said forming, wherein the adhesive layer included in the sealing member is foamed by said heating to adhere to one of the separators.

In said forming, the adhesive layer or the one of the separators may contain water or a solvent, and in said heating, the water or the solvent foams, and thereby, the adhesive layer foams.

The one of the separators may be provided with a projection that is higher than a thickness of the adhesive layer in said forming, and in said heating, the adhesive layer foams, and thereby, the thickness of the adhesive layer becomes thicker than a height of the projection.

### Advantageous Effects

The present disclosure can suppress a deterioration in sealability over time in a fuel cell.

### BRIEF DESCRIPTION OF DRAWINGS

FIG. 1 is a plan view of a power generating unit cell 10;

FIG. 2 shows a cross section of a power generating part 11, and illustrates a layer structure in the power generating part 11;

FIG. 3 shows a cross section of a circumferential part 21, and illustrates a layer structure in the circumferential part 21;

FIG. 4 is a partially enlarged view of FIG. 3;

FIG. 5 shows a cross section taken along C-C of FIG. 4;

FIG. 6 shows other embodiments from the same viewpoint as FIG. 5;

FIG. 7 illustrates a fuel cell stack 30;

FIG. 8 illustrates a method of producing a fuel cell; and

FIG. 9 is a partially enlarged view of FIG. 8.

### DESCRIPTION OF EMBODIMENTS

### 1. Power Generating Unit Cell

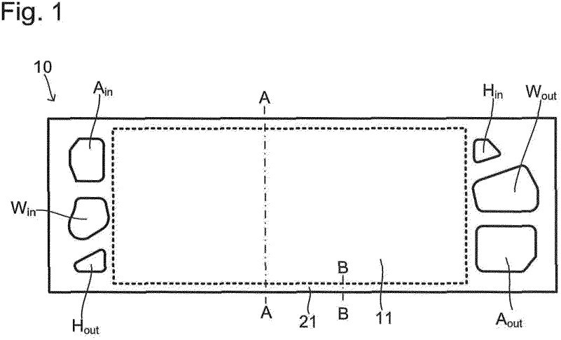

FIGS. 1 to 3 each illustrate a power generating unit cell 10 according to one embodiment. The power generating unit cell 10 is a unit element for generating electricity by the supply of hydrogen and oxygen (air). A plurality of such power generating unit cells 10 are stacked to constitute a fuel cell stack.

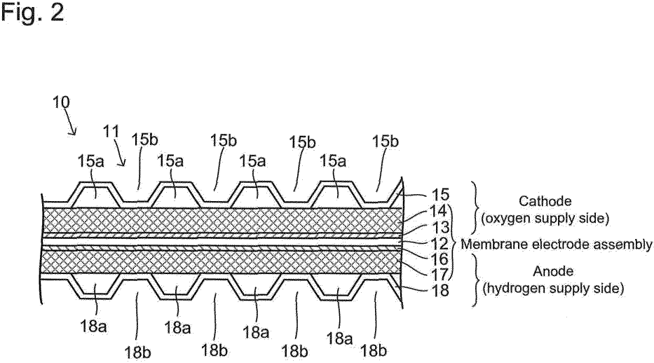

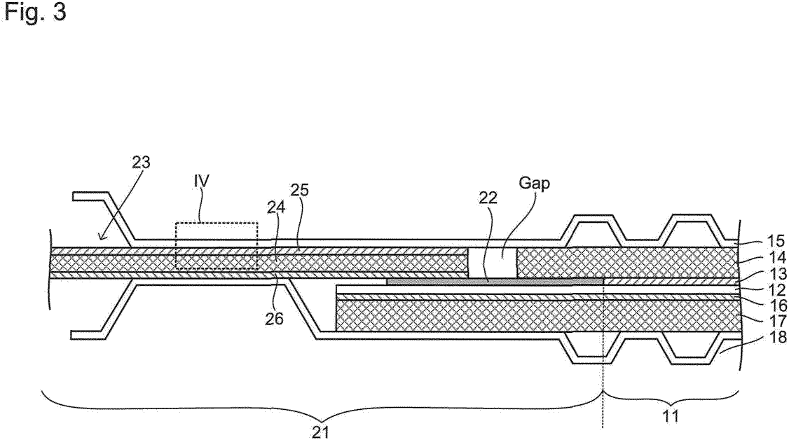

FIG. 1 is a plan view of the power generating unit cell 10, FIG. 2 illustrates a layer structure in a power generating part 11 in the power generating unit cell 10, and FIG. 3 illustrates a layer structure in the circumferential part 21 in the power generating unit cell 10.

### 1.1. Power Generating Part

The power generating part 11 is a part that contributes to the generation of electricity, for example, in a portion surrounded by the dotted line of FIG. 1. The power generating part 11 is formed by stacking plural layers as shown by the layer structure therein in FIG. 2 (part of a cross section taken along A-A).

Across an electrolyte membrane 12, one side of the power generating part 11 in the power generating unit cell 10 is a cathode (oxygen supply side), and the other side thereof is an anode (hydrogen supply side). The cathode is formed by stacking a cathode catalyst layer 13, a cathode diffusion layer 14, and a cathode separator 15 in this order from the electrolyte membrane 12 side. The anode is provided with an anode catalyst layer 16, an anode diffusion layer 17, and an anode separator 18 in this order from the electrolyte membrane 12 side. A stack formed of the electrolyte membrane 12, the cathode catalyst layer 13, the cathode diffusion layer 14, the anode catalyst layer 16, and the anode diffusion layer 17 may be referred to as a membrane electrode assembly. The membrane electrode assembly herein typically has a thickness of approximately 0.4 mm. The thickness of a portion of the power generating unit cell 10 which includes the power generating part 11 is typically approximately 1.3 mm.

Each of the layers may be formed as known, for example, as follows.

### 1.1A. Electrolyte Membrane

The electrolyte membrane 12 is a solid polymer thin film that exhibits excellent proton conductivity in a wet state.

The electrolyte membrane 12 is formed of, for example, a fluorine-based ion exchange membrane. For example, a carbon-fluorine-based polymer may be used. Specific examples of this carbon-fluorine-based polymer include perfluoroalkylsulfonic acid polymers (Nafion (registered trademark)).

The thickness of the electrolyte membrane 12 is not particularly limited, but is at most 100 µm, preferably at most 50 µm, and more preferably at most 10 µm.

### 1.1B. Cathode Catalyst Layer

The cathode catalyst layer 13 is a layer that contains a catalytic metal supported by a carrier. Examples of the catalytic metal herein include Pt, Pd, Rh, and alloys each containing any of them. Examples of the carrier herein include carbon carriers; and more specific examples thereof include carbon particles each made from glassy carbon, carbon black, activated carbon, coke, natural graphite, artificial graphite, or the like.

### 1.1C. Anode Catalyst Layer

The anode catalyst layer 16 is, as well as the cathode catalyst layer 13, a layer that contains a catalytic metal supported by a carrier. Examples of the catalytic metal herein include Pt, Pd, Rh, and alloys each containing any of them. Examples of the carrier herein include carbon carriers; and more specific examples thereof include carbon particles each made from glassy carbon, carbon black, activated carbon, coke, natural graphite, artificial graphite, or the like.

### 1.1D. Cathode Diffusion Layer

The cathode diffusion layer 14 may be formed of, for example, an electroconductive porous body. More specific examples of the cathode diffusion layer 14 include porous carbon (including carbon papers, carbon cloths, and glassy carbon), and porous metals (including metal meshes and metal foams).

The cathode diffusion layer may be provided with an MPL (microporous layer) if necessary. The MPL is a coating-like thin film with which the cathode diffusion layer 14 is coated on the cathode catalyst layer 13 side. The MPL has a function of adjusting a moisture content with water repellency and a hydrophilicity thereof if necessary. The MPL herein typically contains, as principal components, a water repellent resin such as polytetrafluoroethylene (PTFE), and an electroconductive material such as carbon black.

### 1.1E. Anode Diffusion Layer

The anode diffusion layer 17 may be formed of, for example, an electroconductive porous body. More specific examples of the anode diffusion layer 17 include porous carbon (including carbon papers, carbon cloths, and glassy carbon), and porous metals (including metal meshes and metal foams).

### 1.1F. Cathode Separator

The cathode separator 15 is a member via which a reactant gas (air in this embodiment) is supplied to the cathode diffusion layer 14. The cathode separator 15 has plural grooves 15a on a side thereof which faces the cathode diffusion layer 14. These grooves function as reactant gas paths. The shape of the grooves is not particularly limited as long as the reactant gas can be properly supplied to the cathode diffusion layer 14. An example of the shape of the grooves is a shape formed by a serpentine that is formed by shaping a board-like member into waves as this embodiment. In this case, the board typically has a thickness of 0.1 mm to 0.2 mm; and the height of the waves is typically approximately 0.5 mm.

When the shape of the grooves is by a serpentine, a groove 15b is formed between every two adjacent grooves 15a on the opposite side of the grooves 15a across the cathode separator 15. These grooves 15b function as cooling water paths.

As can be seen from FIG. 1, the cathode separator 15 is further provided with an air inlet port Aᵢₙ, a cooling water inlet port Wᵢₙ, and a hydrogen outlet port Hₒᵤₜ at a portion located extendedly outside the power generating part 11 on one ends side of the grooves 15a and 15b; and an air outlet port Aₒᵤₜ, a cooling water outlet port Wₒᵤₜ, and a hydrogen inlet port Hᵢₙ at a portion located extendedly outside the power generating part 1I on the other ends side of the grooves 15a and 15b. Here, the grooves 15a communicate with the air inlet port Aᵢₙ and the air outlet port Aₒᵤₜ; and the grooves 15b communicate with the cooling water inlet port Wᵢₙ and the cooling water outlet port Wₒᵤₜ.

The material constituting the cathode separator 15 may be any material that can be used for a separator for a power generating unit cell, and may be a gas-impermeable electroconductive material. Examples of such a material include dense carbon that is formed by compressing carbon to be impermeable to gasses, and press-molded metal plates.

### 1.1G. Anode Separator

The anode separator 18 is a member via which a reactant gas (hydrogen) is supplied to the anode diffusion layer 17. The anode separator 18 has plural grooves 18a on a side thereof which faces the anode diffusion layer 17. These grooves function as reactant gas paths. The shape of the grooves is not particularly limited as long as the reactant gas can be properly supplied to the anode diffusion layer 17. An example of the shape of the grooves is a shape formed by a serpentine as this embodiment.

In this case, the board as described above typically has a thickness of 0.1 mm to 0.2 mm; and the height of the waves of the serpentine is typically approximately 0.4 mm.

When the shape of the grooves is by a serpentine, a groove 18b is formed between every two adjacent grooves 18a on the opposite side of the grooves 18a across the anode separator 18. These grooves 18b function as cooling water paths.

As can be seen from FIG. 1, the anode separator 18 is further provided with the air inlet port Aᵢₙ, the cooling water inlet port Wᵢₙ, and the hydrogen outlet port Hₒᵤₜ at a portion located extendedly outside the power generating part 11 on one ends side of the grooves 18a and 18b; and the air outlet port Aₒᵤₜ, the cooling water outlet port Wₒᵤₜ, and the hydrogen inlet port Hᵢₙ at a portion located extendedly outside the power generating part 11 on the other ends side of the grooves 18a and 18b. Here, the grooves 18a communicate with the hydrogen inlet port Hᵢₙ and the hydrogen outlet port Hₒᵤₜ; and the grooves 18b communicate with the cooling water inlet port Wᵢₙ and the cooling water outlet port Wₒᵤₜ.

The material constituting the anode separator 18 may be any material that can be used for a separator for a power generating unit cell, and may be a gas-impermeable electroconductive material. Examples of such a material include dense carbon that is formed by compressing carbon to be impermeable to gasses, and press-molded metal plates.

### 1.1H. Generation of Electricity in Power Generating Part

Electricity is generated as known by the power generating unit cell 10 as follows.

When hydrogen is supplied via the grooves 18a of the anode separator 18, the ·hydrogen passes through the anode diffusion layer 17, and is resolved in the anode catalyst layer 16 into protons (H+) and electrons (e⁻). The protons pass through the electrolyte membrane 12, and the electrons pass through a conducting wire that connects to the outside, to each reach the cathode catalyst layer 13. Here, oxygen (air) is supplied to the cathode catalyst layer 13 from the grooves 15a of the cathode separator 15 via the cathode diffusion layer 14, and water (H₂O) is generated in the cathode catalyst layer 13 by the protons, the electrons, and the oxygen. The generated water passes through the cathode diffusion layer 14 to reach the grooves 15a of the cathode separator 15, and is discharged.

That is, in the power generating unit cell 10, the flow of the electrons passing through the conducting wire, which connects to the outside from the anode catalyst layer 16, is utilized as an electric current.

### 1.2. Circumferential Part

The circumferential part 21 is a circumferential part of the power generating unit cell 10 and is outside the power generating part 11, which is surrounded by the dotted line in FIG. 1. The circumferential part 21 is formed by stacking plural layers as shown by the layer structure in the circumferential part 21 (a cross section taken along B-B) in FIG. 3.

As can be seen from FIG. 3, in this embodiment, the circumferential part 21 has the following structure.

An end face of each of the electrolyte membrane 12, the anode catalyst layer 16, and the anode diffusion layer 17 is located as protruding more than (progressing beyond) an end face of the cathode catalyst layer 13; and the electrolyte membrane 12, the anode catalyst layer 16, and the anode diffusion layer 17 are stacked so that the end faces thereof are approximately at the same position. An end face of the cathode diffusion layer 14 is located as protruding more than (progressing beyond) the end face of the cathode catalyst layer 13, but as retreating behind the end face of the electrolyte membrane 12.

A cover sheet 22 is extendedly arranged over the electrolyte membrane 12 on the cathode side so as to extend from the end face of the cathode catalyst layer 13 toward the end face of the electrolyte membrane 12. The cover sheet 22 is a sheet made from a material (e.g., nylon) that is impermeable to reactant gasses such as hydrogen and oxygen. One end side of the cover sheet 22 is arranged between the electrolyte membrane 12 and the cathode diffusion layer 14.

A resin sheet 23 is arranged over the cover sheet 22 on the cathode side on the other end side of the cover sheet 22. As can be seen from FIG. 3, one end face of the resin sheet 23 is arranged so as to face the end face of the cathode diffusion layer 14 with a gap therebetween; and the resin sheet 23 extends so that the other end face thereof, which is omitted in FIG. 3, protrudes much more than the end face of the electrolyte membrane 12. The resin sheet 23 will be further described later.

This gap can absorb dimensional changes due to linear expansion of the resin sheet 23 and the cathode diffusion layer 14, which can suppress breakage due to expansion and contraction.

The cathode separator 15 and the anode separator 18 are arranged so as to hold the layers therebetween in the same manner as the power generating part 11. Thus, the cathode separator 15 and the anode separator 18 are bent so that the distance therebetween varies according to the layers held therebetween. As can be seen from FIG. 3, this distance is smaller at part of a portion where only the resin sheet 23 is arranged: in such part, the resin sheet 23 is held between and fixed by the cathode separator 15 and the anode separator 18.

No groove 15a or 18a is formed on the cathode separator 15 and the anode separator 18 in the circumferential part 21 since no path is necessary in the circumferential part 21 (it is noted that the grooves may be formed in part of the circumferential part 21 as can be seen from FIG. 3).

### 1.2A. Resin Sheet

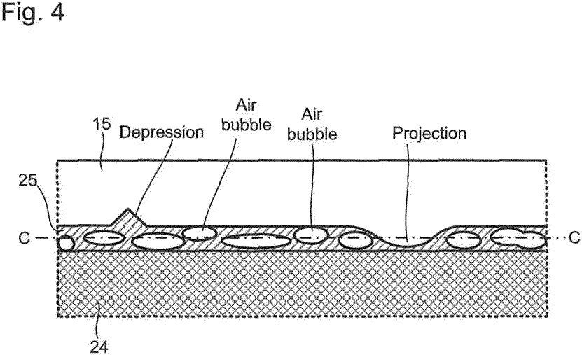

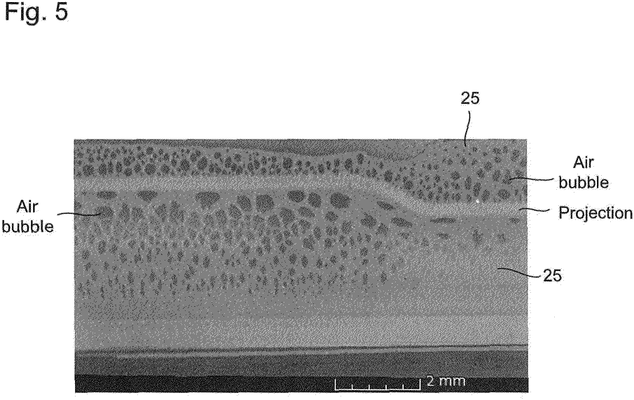

In the circumferential part 21 of the power generating unit cell 10, the resin sheet 23 functions as a sealing member with which the space between the cathode separator 15 and the anode separator 18 is sealed. FIG. 4 is an enlarged view of the portion indicated by IV in FIG. 3. FIG. 5 shows an example of a cross section taken along C-C of FIG. 4.

The resin sheet 23 includes a base material 24, an adhesive layer 25 disposed on one face of the base material 24 (a face facing the cathode), and an adhesive layer 26 disposed on the other face of the base material 24 (a face facing the anode). The adhesive layer 25 adheres to the cathode separator 15, and the adhesive layer 26 adheres to the anode separator 18; thereby, the power generating part 11 is sealed.

The base material 24 is formed from an electrically insulating, and airtight thermoplastic resin material of a relatively high melting point. Examples of such a material include polyethylene naphthalate, polyphenylene ether, and polyphenylene sulfide. Use of a resin material of a high melting point prevents the base material 24 from melting even when heating is performed for forming bubbles in the adhesive layers 25 and 26 as described later, and can suppress a change in dimension and shape.

The thickness of the base material 24 is not particularly limited, but is preferably 0.05 mm to 0.25 mm.

The adhesive layers 25 and 26 are layers that have adhesiveness and that contain many bubbles in an adhered state.

The adhesive layers 25 and 26 are sufficient if a material which expresses adhesiveness is used therefor. Examples of such a material include modified polyolefins each formed by introducing a functional group (such as maleic anhydride and an epoxy) into a polyolefin to give adhesiveness; and more specific example thereof is ADMER (registered trademark) from Mitsui Chemicals, Inc.

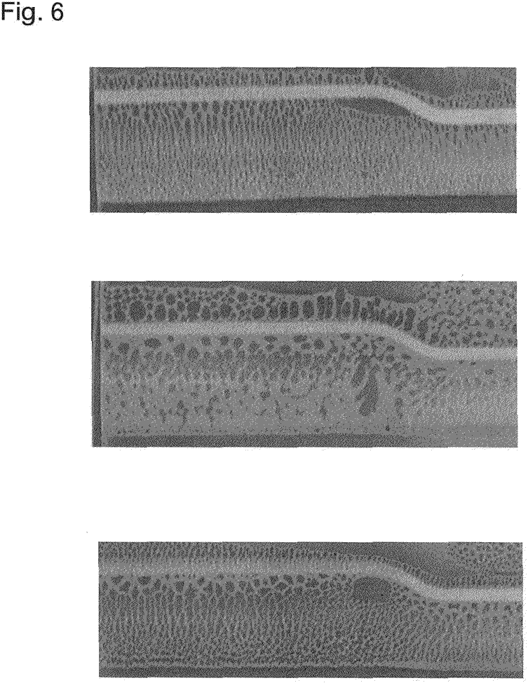

The bubbles are formed by a production method described later. As can be seen from FIG. 5, the bubbles do not have uniform shape and size, but have a variety of shapes and sizes without any limitations. Preferably, each of the bubbles roughly have a size of approximately at most 0.6 mm in diameter from the viewpoint of FIG. 5. In FIG. 6, the drawings according to other three embodiments are listed. In FIG. 6, the viewpoints are the same as FIG. 5.

The percentage of the bubbles (air content) in the adhesive layers 25 and 26 is 10% to 80%, more preferably 30% to 80%, and further preferably 50% to 80%.

The air content is measured as follows: a cross section parallel to a layer plane (a cross section taken along C-C) at the center in the layer thickness of each adhesive layer is observed by X-ray CT or with an optical microscope, so that the percentage of the area of the bubbles within the observed field (a circle of 2 mm in diameter) is obtained. This allows the adhesive layers to have adhesive strength, and to fit depressions and projections of the separators when the adhesive layers are foamed and expanded. The air content lower than 10% may lead to such an insufficient volume of the adhesive layers that the space is not filled with the adhesive layers, and insufficient sealability. The air content higher than 80% may lead to a tendency for adhesive strength to decline. In such a view, an appropriate content of the bubbles improves adhesiveness, and also allows the function of filling the space (sealability) to be obtained.

The adhesive strength of the adhesive layers 25 and 26 is set so as to be more than 0.2 N/mm when measured by 90° peel conforming to JIS K 6854-1:1999 (ISO 8510-1:1990), or T-peel conforming to JIS K 6854-3:1999 (ISO 11339:1993).

Depressions and projections are formed on the adhesive layer 25 on a side thereof adhered to the cathode separator 15, and the adhesive layer 26 on a side thereof adhered to the anode separator 18: these depressions and projections correspond to depressions and projections on the surface of each of the separators when the adhesive layers are foamed and expanded when adhered (described later). That is, for projections on the surfaces of the separators, depressions are formed on the adhesive layers; and for depressions on the surfaces of the separators, projections are formed on the adhesive layers. An adhesive fills the space between the base material and the separators, which includes the depressions and projections of the separators, to form the adhesive layers.

Examples of such projections on the surfaces of the separators include projections (approximately 0.04 mm in height) intentionally provided for enhancing sealability, and projections unintentionally generated in production.

Examples of the depressions on the surfaces of the separators include cracks and faults.

The adhesive layers 25 and 26, both of which contain the above-described bubbles, have been described. The present disclosure is not limited to this as long as either one of the adhesive layers 25 and 26 has the above-described structure.

### 2. Fuel Cell Stack

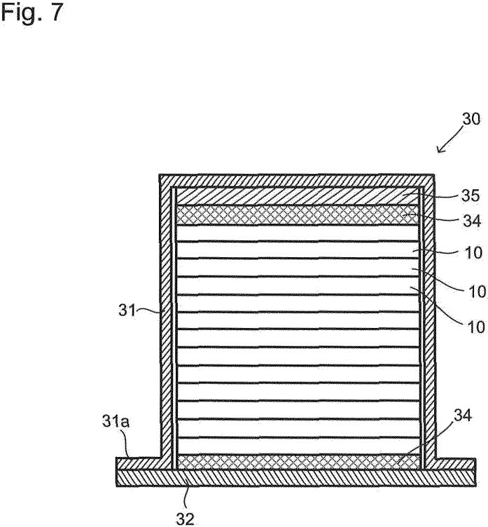

A fuel cell stack 30 is a member that is formed by stacking the plural (approximately 50 to 400) power generating unit cells 10, and collects a current from the plural power generating unit cells 10. FIG. 7 schematically shows the structure of the fuel cell stack 30. The fuel cell stack 30 is provided with a case for a stack 31, an end plate 32, the plural power generating unit cells 10, current collector plates 34, and a biasing member 35.

The case for a stack 31 is a housing which houses the stacked plural power generating unit cells 10, the current collector plates 34, and the biasing member 35 thereinside. In this embodiment, the case for a stack 31 is in the form of a quadrangular tube with one end open and the other end close. A board-like piece overhangs toward the opposite side of the opening at the one end along the edge of the opening to form a flange 31a.

The end plate 32 is a board-like member, and covers the opening of the case for a stack 31. The end plate 32 is fixed to the case for a stack 31 with bolts and nuts or the like along the portion overlapping with the flange 31a of the case for a stack 31 so as to cover the case for a stack 31.

The power generating unit cells 10 are as described above. Such plural power generating unit cells 10 are stacked. At this time, the anode separator 18 of one of every two adjacent power generating unit cells 10 is arranged to stacked on the cathode separator 15 of the other one of said every two adjacent power generating unit cells 10. The grooves 15b of the cathode separator 15 and the grooves 18b of the anode separator 18 of every two adjacent _power_generating unit cells_10 face each other to_form the_cooling water_paths._

The current collector plates 34 are members that collect currents from the stacked power generating unit cells 10. Therefore, the current collector plates 34 are arranged on one and the other ends of a stack of the power generating unit cells 10 in the stacking direction, respectively. One of the current collector plates 34 is a cathode, and the other thereof is an anode. Terminals (not shown) are connected to these current collector plates 34 so as to be electrically connectable to the outside.

The biasing member 35 is stored inside the case for a stack 31. With the biasing member 35, a pressing force is applied to the stack of the power generating unit cells 10 in the stacking direction. An example of the biasing member is a disc spring.

### 3. Methods of Producing Power Generating Unit Cell and Fuel Cell Stack

For example, a power generating unit cell according to the present disclosure may be produced as follows.

### 3.1. Stack Formation Step

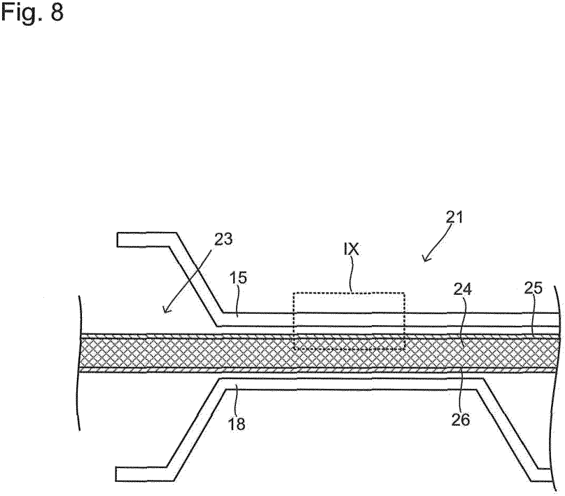

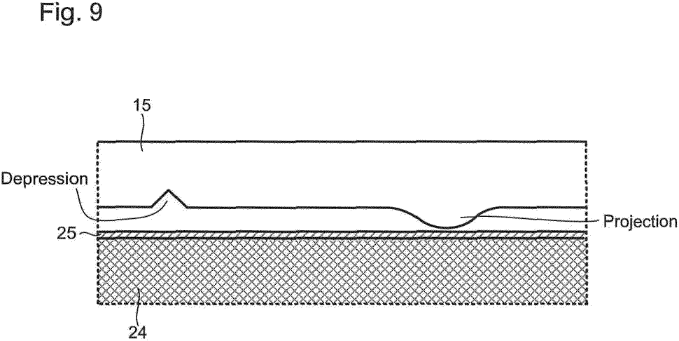

The layers of the power generating unit cell 10 are arranged between the cathode separator 15 and the anode separator 18 in the same manner as described above. At this time, no bubble is contained in the adhesive layers 25 and 26 of the resin sheet 23 (the adhesive layers 25 and 26 do not foam yet), so that the resin sheet 23 is thin. Thus, as shown in FIGS. 8 and 9 (FIG. 9 is an enlarged view of the portion indicated by IX of FIG. 8), none of the space between the cathode separator 15 and the resin sheet 23, and the space between the anode separator 18 and the resin sheet 23 are filled with the adhesive layers 25 and 26. At this time, the thickness of each of the adhesive layers 25 and 26 (before foaming) is not particularly limited, but is approximately 0.02 mm to 0.06 mm.

The air content before foaming is preferably at most 5%.

When the cathode separator 15 and the anode separator 18 are intentionally provided with projections, the thickness of each of the adhesive layers 25 and 26 in this case may be thinner than the projecting amount of these projections.

At this time point, at least one of the adhesive layer 25, the adhesive layer 26, the cathode separator 15, and the anode separator 18 may contain a solvent (water or an organic solvent (such as toluene)) for promoting foaming.

### 3.2. Heating Step

Next, after arranged as described above, the layers are constrained with a metal mold or the like and heated, so that the adhesive layers 25 and 26 are foamed, and the space between the cathode separator 15 and the base material 24 and the space between the anode separator 18 and the base material 24 are filled with the foamed adhesive layers 25 and 26 as in FIGS. 3 to 6. According to this, the spaces between the separators and the base material, which include the depressions and the projections, are filled with the adhesive layers, and the adhesive layers are adhered to the separators.

The heating temperature is at least the melting point of an adhesive of the adhesive layers (preferably 20° C. higher than the melting point), and at least the boiling point of the solvent (at least 100° C. when the solvent is water; and at least 111° C. when the solvent is toluene).

### 3.3. Production of Fuel Cell Stack

The power generating unit cell 10 is produced as described above. A plurality of these power generating unit cells 10 are prepared and stacked to form the structure as shown in FIG. 7 by a known method; thereby, the fuel cell stack 30 can be produced.

### 4 Effects, Etc

According to the present disclosure, the adhesive layers are foamed with heat when adhered; thereby, adhesion and space filling can be simultaneously performed. In other words, even if there are projections and depressions on the separators, the space between the separators can be sealed by filling the space with the foamed adhesive layers. This allows the adhesive layers to be strongly adhered since the contact area of these adhesive layers increases more than that of an adhesive layer without foaming.

The sealing with the adhesive layers according to the present disclosure is not by an elastic reaction force but by an adhesive force. Thus, a chronological deterioration in sealability can be suppressed, and good durability can be obtained.

The adhesive layers before foaming may be thin (may be thinner than the height of the projections of the separators) since the thickness of each of the adhesive layers is increased by foaming, which makes it possible to efficiently form the adhesive layers in view of productivity and cost.

### REFERENCE SIGNS LIST

10 power generating unit cell
11 power generating part
12 electrolyte membrane
13 cathode catalyst layer
14 cathode diffusion layer
15 cathode separator
16 anode catalyst layer
17 anode diffusion layer
18 anode separator
21 circumferential part
22 cover sheet
23 resin sheet
24 base material
25 adhesive layer
26 adhesive layer
30 fuel cell stack

What is claimed is:

1. A sealing member that is arranged between a cathode separator and an anode, separator, with the sealing member the cathode separator and the anode separator being adhered and a space therebetween being sealed, the cathode separator and the anode separator being provided for a power generating unit cell in a fuel cell, the sealing member comprising:
a base material; and
an adhesive layer arranged on at least one face of the base material, wherein
the adhesive layer contains many bubbles in an adhered state.

2. The sealing member according to claim 1, wherein a percentage of the bubbles in the adhesive layer in the adhered state is 10% to 80%.

3. A power generating unit cell for a fuel cell, the power generating unit cell being formed by holding a membrane electrode assembly between two separators, wherein
the sealing member according to claim 1 is arranged outside a circumferential part of the membrane electrode assembly, and
the adhesive layer adheres to one of the separators.

4. The power generating unit cell according to claim 3, wherein a peel strength for adhesion of the adhesive layer to the one of the separators is more than 0.2 N/mm.

5. A method of producing a fuel cell, the method comprising:
forming a stack by arranging a membrane electrode assembly between two separators, outside a circumference of the membrane electrode assembly a sealing member including at least one adhesive layer being arranged, and
heating the stack formed by said forming, wherein
the adhesive layer included in the sealing member is foamed by said heating to adhere to one of the separators.

6. The method according to claim 5, wherein
in said forming, the adhesive layer or the one of the separators contains water or a solvent, and
in said heating, the water or the solvent foams, and thereby, the adhesive layer foams.

7. The method according to claim 5, wherein
the one of the separators is provided with a projection that is higher than a thickness of the adhesive layer in said forming, and
in said heating, the adhesive layer foams, and thereby, the thickness of the adhesive layer becomes thicker than a height of the projection.
